(19) United States
(12) Patent Application Publication
(10) Pub. No.: US 2009/0070840 A1
(43) Pub. Date: Mar. 12, 2009

(54) Terminal-Cooperated System, Terminal, Server and Method for Uninterrupted Reception of Contents

(75) Inventors: Hideki Kamimaki, Fujisawa (JP); Nobuhiro Sekimoto, Tachikawa (JP); Hiroki Miyamoto, Fujisawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 12/204,429

(22) Filed: Sep. 4, 2008

(30) Foreign Application Priority Data
Sep. 5, 2007 (JP) 2007-229654
Nov. 28, 2007 (JP) 2007-306749

(51) Int. Cl. H04N 7/173

(52) U.S. Cl. 725/114

(57) ABSTRACT

In a terminal-cooperated system for the uninterrupted reception of contents, the information receiving terminal apparatus includes a unit for transmitting to the mobile terminal the information on content reception switching, and the video information system can uninterruptedly switch over the content reception from the mobile terminal to the information receiving terminal apparatus and from the information receiving terminal apparatus to the mobile terminal, by operating the mobile terminal.

### INCORPORATION BY REFERENCE

This application claims priority from Japanese Patent Application JP2007-229654, filed on Sep. 5, 2007, and JP2007-306749, filed on Nov. 28, 2007. The content of which is hereby incorporated by reference into this application.

### BACKGROUND OF THE INVENTION

The present invention relates to a system or the like for receiving contents such as audiovisual programs, and more particularly to a system or the like for uninterrupted reception of contents by plural apparatuses via a network.

As a prior art in the same technical field is known JP-A-2004-336310, whose object is “to enable the content being received by a first terminal to be seamlessly switched over to a second terminal without need for login by the second terminal when the reception or display of the content is switched from the first terminal to the second terminal” (refer to paragraph [0006] of JP-A-2004-336310). To attain the object, the description of JP-A-2004-336310, especially paragraph [0008], goes as follows: “The object can be attained by a system for seamless handover of contents (MetaPORT) in collaboration with an audiovisual reception history managing server in compliance with the TV-Anytime Forum Standard, a content meta-server, a location solving server and a presence managing server in compliance with the IETF Standard. The MetaPORT is an audiovisual uninterrupted reception control server (MetaPORT server) that realizes as a net work service the Suspend and Resume function for switching the context of the content being received by a user's terminal to a network, which in turn delivers the taken content to another terminal as deliver destination that finally reproduces the content delivered thereto in conformity with the presence of the deliver destination. The user is provided with a user interface which can select the content deliver source/destination on the screen of the terminal (MetaPORT terminal) and issues a handover instruction; access is made to the presence server and the location solving server; and the function for seamless handover of content to the content deliver destination is realized.”

Further, JP-A-2005-323068 known as another prior art in the same technical field discloses as the object of the invention “to offer a home network AV server and a home network AV server program which are very convenient in use since when a user interrupts the reception of a content while viewing the content in an ordinary home network environment, the reproduction of the content can be resumed easily starting from the very point of interruption.” (refer to paragraph of JP-A-2005-323068) To attain the object, the description of JP-A-2005-323068, especially paragraph [0007], goes as follows: “ . . . The home network AV server incorporates therein a data transmission position detecting section for detecting the current transmission position of the content data transmitted to the client terminal and a midway-resuming content information producing section for forming a midway-resuming content information that determines as a reproduction resuming position the position of data whose reproduction was stopped on the basis of the current transmission position of the content data outputted from the data transmission position detecting section in response to the reception of the reproduction stopping demand from the client terminal and for storing the formed midway-resuming content information in the content information list storage section. The transmission data producing section transmits the content data immediately from after the reproduction resuming position through reference to the midway-resuming content information stored in the content information list storage section, in response to the audiovisual reproduction resuming demand from the client terminal.”

### SUMMARY OF THE INVENTION

According to the configurations disclosed in the above described documents, JP-A-2004-336310 and JP-A-2005-323068, the center equipment such as, for example, the audiovisual content reception history managing server must be on a large scale to provide uninterrupted reception of contents in an intra-home network. Moreover, continuity in content viewing is breached at the point of interruption of audiovisual reception so that quality in preserving the continuity of content display is impaired in the system consisting of the content delivering server, the content-deliver-source terminal and the content-deliver-destination terminal (e.g. stream of images may become discontinuous).

When the audiovisual environment of interest is limited only within the AV home server or the intra-home network, the advantage enjoyable by the mobile terminal that the audiovisual environment can be offered irrespective of geographical locations, may be impaired.

Further, JP-A-2004-336310 and JP-A-2005-323068 do not take into consideration the situation where while some people are viewing a certain content on a TV receiver, one or more of them starts viewing the same content continuously by means of his/her mobile terminal at a place apart from the TV receiver whereas the rest of the people continue to view the content on the TV receiver.

Moreover, JP-A-2004-336310 and JP-A-2005-323068 provide only a little consideration for easy switchover of content. For example, a user must do a lot of work in making decision on whether the content switchover is from the mobile terminal to the TV receiver or from the TV receiver to the mobile terminal and in adjusting the differences in output capabilities (e.g. screen sizes) between the mobile terminal and the TV receiver.

It is therefore preferable that a reception terminal apparatus such as, for example, a home TV receiver not only offer contents for watchers at home but also can provide, if needs arise, the continuous reception of the same contents by a mobile terminal apparatus held by an individual.

In a concrete example, the mobile terminal apparatus such as a cellular phone held by an individual user is so constructed as to be equipped with a unit for obtaining audiovisual information to be displayed on the screen of his/her family's TV receiver and a unit for sending a content deliver demand to the content delivering apparatus installed in the service center on the basis of the audiovisual information and for transmitting the control information on whether or not the continuous reception of content is to be done by the reception terminal apparatus.

Further, the reception terminal apparatus incorporates therein a unit for transmitting to the mobile terminal apparatus the information on the status viewed on the reception terminal apparatus and the parameters for mobile reception.

The content delivering apparatus controls the audiovisual environment that satisfies the demands of plural users. The mobile terminal apparatus, the reception terminal apparatus and the content delivering apparatus are linked with one another by the help of such information as mobile content reception parameters including time codes. Thus, the audiovisual content being viewed on the reception terminal apparatus can be uninterruptedly switched to the mobile terminal apparatus, or reversely, the audiovisual content being viewed on the mobile terminal apparatus can be uninterruptedly switched to the reception terminal apparatus.

With such a configuration as described above, while a content is being enjoyed by a family on the large screen of a reception terminal apparatus (e.g. TV receiver) placed in the family's living room, each member of the family can obtain information or data in accordance with his/her liking by a mobile terminal apparatus which can be carried around by him/her.

Further, the terminal-cooperated system is provided with a unit for switching the display of video images from the mobile terminal apparatus to the information receiving terminal apparatus and from the information receiving terminal apparatus to the mobile terminal apparatus, through the operation of the mobile terminal apparatus on the basis of the information on how the display is to be switched. Moreover, the terminal-cooperated system may be provided with a unit for discriminating the sorts of contents, a unit for transmitting and receiving information on the display resolution and the screen size of the information receiving terminal apparatus or the mobile terminal apparatus which is the object of content reception switching, and a unit for changing the display resolution and the screen size on the basis of the information.

Those units can easily realize the uninterrupted switching of content adapted to the case of plural apparatus and/or plural users.

Also, those units can easily realize the reception of content by plural apparatuses.

Other objects, features and advantages of the invention will become apparent from the following description of the embodiments of the invention taken in conjunction with the accompanying drawings.

### BRIEF DESCRIPTION OF THE DRAWINGS

FIG. 1 schematically shows an example of an audiovisual system for providing the uninterrupted viewing of images switched to an associated mobile terminal;

FIG. 2 illustrates an example of the sequence of protocol for mobile display switching;

FIG. 3 schematically shows another example of an audiovisual system for providing the uninterrupted viewing of images switched to an associated mobile terminal;

FIG. 4 illustrates an example of the sequence of protocol for the mobile uninterrupted reception of contents;

FIG. 5 shows an example of a menu displayed on a manipulating screen;

FIG. 6 shows in block diagram the circuit configurations of a mobile terminal 100 and an information receiving terminal apparatus 101;

FIG. 7 shows an example of a mode selection screen associated with the mobile terminal; and

FIG. 8 shows in block diagram the circuit configurations of a mobile terminal 100 and an information receiving terminal apparatus 101, both using super-resolution techniques.

### DESCRIPTION OF THE EMBODIMENTS

Embodiments of the present invention will now be described below in reference to the attached drawings. The present invention, however, is by no means limited to those described embodiments alone. In the embodiments are exemplified systems each consisting mainly of a mobile terminal connected with a network, an information receiving terminal apparatus such as, for example, a digital TV, and a content delivering apparatus.

### Embodiment 1

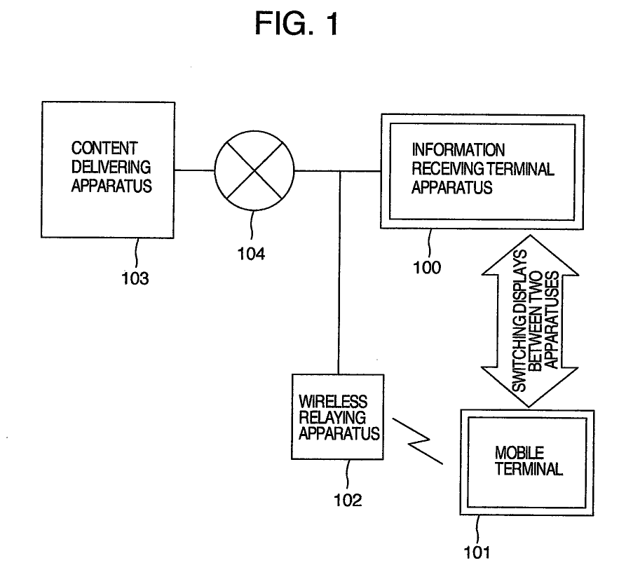

FIG. 1 schematically shows an example of an audiovisual system for providing the uninterrupted viewing of images switched to an associated mobile terminal. Description is made of a case where when all the members of a family are enjoying audiovisual contents in a living room by means of an information receiving terminal apparatus 100 such as television receiver (TV) connected with a network, a member of the family wants to separately receive the same contents by his/her mobile terminal while moving or in another place other than the living room.

As shown in FIG. 1, the information receiving terminal apparatus 100 receives a video stream delivered via a broadband internet line 104 from a content delivering apparatus 103, and displays on its screen the contents contained in the video stream. A mobile terminal 101 is connected via a wireless relaying apparatus 102 with the network and can receive audiovisual contents in accordance with its performance and functions. In this embodiment, it is assumed that the information receiving terminal apparatus 100 is a television receiver. It is to be noted here that the information receiving terminal apparatus 100 and the mobile terminal 101 are termed collectively as reception terminal or reception terminal apparatus.

Each of the information receiving terminal apparatus 100, the mobile terminal 101 and the content delivering apparatus 103 includes pieces of hardware such as a CPU, a memory and a communication IF. The CPU executes associated software and performs the reception/transmission and the controls of reception/transmission. The sites in the CPU where reception, transmission and control are performed, are named a reception section, a transmission section and a control section, respectively.

In this embodiment, the information receiving terminal apparatus 100 is described as receiving the video stream via the broadband internet line 104, but it may receive a video stream from the broadband internet line 104 and/or a digital TV broadcast network. The broadband internet line 104 may include optical fibers such as FTTH, ADSL or wireless LAN.

In this embodiment, mutual display switchover is performed between the information receiving terminal apparatus 100 and the mobile terminal 101. Mutual display switchover means the switchover of audiovisual contents from one terminal to another among plural terminals. For example, such switchover occurs when the reception of a certain content is switched over from the information receiving apparatus 100 for family use to an individual mobile terminal possessed of by each member of the family, or vice versa, through the actuation of the button on the individual mobile terminal. Even the display of the same content on both the information receiving terminal apparatus 100 and/or the mobile terminal 101 is referred to as “switchover” of display in this embodiment. In this way, the mobile terminal 101, even when it moves out of the living room into another room or out of home, can receive the contents uninterruptedly. Moreover, the meaning of switchover in the sense used in this embodiment includes the output of the content to a separate apparatus other than the information receiving terminal apparatus 100 or the mobile terminal 101 so that the content can be displayed on the screen of the separate apparatus. Such display and external output may be collectively termed “output”.

The mobile terminal 101 can switch over the display screens by instructing, via the wireless relaying apparatus 102, the content delivering apparatus 103 to select the audiovisual contents to be received via the Internet 104 and by specifying the address of the deliver destination. Such switchover can be performed by, for example, causing the mobile terminal 101 to analyze its own address or the address of the information receiving terminal apparatus 100 that serves as the content deliver destination and to make a demand for sending a video stream (referred to also as a transmission demand) to the information receiving terminal apparatus 100 and/or the mobile terminal 101.

The content delivering apparatus 103 performs such deliver control as is suitable to the mobile terminal 101, in response to the transmission demand from the mobile terminal 101. When the content delivering apparatus 103 contains such contents as is suitable to the function of the terminal, it delivers the contents to the information receiving terminal apparatus 100 and/or the mobile terminal 101 as the deliver destination, on the basis of the URL or address information mapped in the contents.

Now, let it be assumed, for example, that the content delivering apparatus 103 has two similar contents which are different from each other only in picture quality, i.e. one with high picture quality and the other with low picture quality. Then, when the content delivering apparatus 103 receives the transmission demand, it makes a decision on whether or not the mobile terminal 101 can display the contents of high picture quality. For example, in making such a decision, the content delivering apparatus 103 fetches the information on the apparatuses as deliver destinations through the use of the functions of Universal Plug and Play (uPnP) defined by Digital Living Network Alliance (DLNA) at the time of connection with the network, discriminates the sorts of contents to be reproduced, and obtains via the network the resource information on the calculation capability and the video processing capability of each apparatus.

For example, contents with low picture quality are delivered to the mobile terminal 101 whereas contents of high picture quality are delivered to the information receiving terminal apparatus 100 that is capable of displaying such contents of high picture quality. When, on the other hand, the content delivering apparatus 103 has a plurality of similar contents differing only in their compression scheme, e.g. MPEG4 and H.264, it selects the contents of such compression scheme as suitable to each apparatus as a delivering destination, converts the compression scheme if necessary, and delivers the contents to the deliver destinations. Further, the process capability of the mobile terminal 101 can be evaluated by providing the content delivering apparatus 103 (i.e. the center side apparatus) with a table showing apparatus IDs and video processing capability through adding the function of fetching the IDs and the vendor names proper to the apparatuses to the function of making the authentication of the apparatuses at the time of their connection with the portal for the content deliver service.

Also, the mobile terminal 101 can control the contents to be received and viewed by the information receiving terminal apparatus 100. The control of the contents means to instruct the information receiving terminal apparatus 100 to start the display of the contents, stop displaying the contents, switch over the reception of the contents, start the mobile reception of the contents, and allow the uninterrupted reception of the contents by the mobile terminal. The manipulation for the audiovisual reception of the contents can be facilitated if a setting file for the control of the contents is prepared in advance. One way to achieve this is to provide the information receiving terminal apparatus 100 with the function of storing the file for control commands sent from the mobile terminal 101 via the network and, as a result, to provide the information receiving terminal apparatus 100 with a table of the operational commands sent from the remote controller for general use and the mobile terminal 101. With such a provision, the information receiving terminal apparatus 100 can decide on whether the control comes from a remote controller or from the mobile terminal 101. Therefore, the control of start and stop of audiovisual content reception can be shared between the remote controller and the mobile terminal 101 so that a single piece of software can be shared between them. This can lead to the reduction of the software scale.

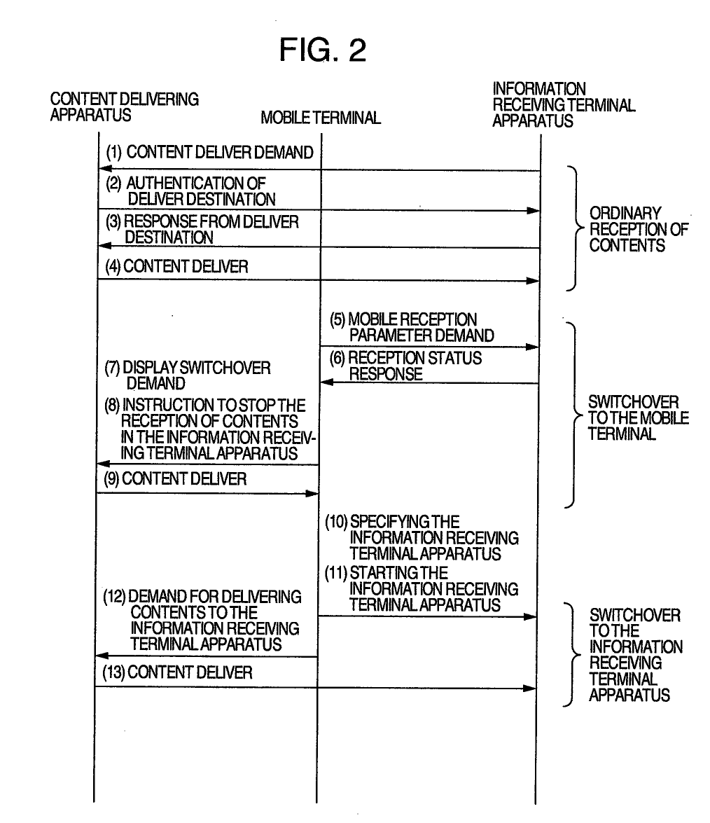

FIG. 2 illustrates an example of the sequence of protocol for mobile display switching used in the system shown in FIG. 1. FIG. 2 actually shows the sequence where the audiovisual contents being received and viewed by the information receiving terminal apparatus 100 is switched to the display on the screen of the mobile terminal 101, or vice versa.

To begin with, for ordinary reception of audiovisual contents, (1) the information receiving terminal apparatus 100 sends out a content deliver demand to the content delivering apparatus 103. In this case, such a demand is realized by selecting a desired content on the service portal screen.

Upon receiving the deliver demand, (2) the content delivering apparatus 103 makes an authentication of the deliver destination, that is, makes a decision on whether or not there is a terminal that serves as the deliver destination other than the information receiving terminal apparatus 100 which sent out the deliver demand. Then, (3) the content delivering apparatus 103 receives the response from the deliver destination that is the information receiving terminal apparatus 100 in this case. Thus, the terminal serving as deliver destination has been authenticated and (4) contents are delivered to the deliver destination.

Under these circumstances, when it is required to switch the display of audiovisual contents from the information receiving terminal apparatus 100 to the mobile terminal 101, (5) the mobile terminal 101 sends out a mobile reception parameter demand to the information receiving terminal apparatus 100 so as to fetch the time code for the content being received by the information receiving terminal apparatus 100.

By (6) receiving the reception status response from the information reception apparatus 100, the mobile terminal 101 obtains the head time code of the content which is under reception by the mobile terminal 101. The head time code is the one which is used to resume the content reception by the mobile terminal 101 after the switching of the content over to the mobile terminal 101.

The mobile reception parameter may include the time code for indicating the instantaneous time point in the content being currently received, the title of the ongoing content, the record of content received in the past that gives time information on how far the content has been viewed before being switched over, and the video processing capability of the apparatus that decides on the sorts of contents to be displayed in reproduction. This embodiment describes a case where the content being currently displayed on the information receiving terminal apparatus 100 is switched to the mobile terminal 100 and also describes the mobile reception using the time code. The time code may indicate the accumulated time of reproduction from the start of a content up to the current instant of display in reproduction, or may be the time stamp such as DTS, PTS or ATS. They are referred to also as time information or synchronizing information.

Some users in the mobile reception of contents want to start reproducing a certain desired content not at the time of its beginning but at the time three minutes before its beginning or at the time immediately after the CM preceding the desired content, that is, at any desired moment in accordance wuth the types of contents. The reception status allows an extension to such a case. Namely, the mobile reception function that provides easy reception of contents for users can be realized by not only returning the status indicating the time code for accurate reception duration but also returning the status corresponding to various user reception modes such as returning a status at the time three minutes after the CM preceding the desired content or one minute after the a certain scene change. The head time code is the time code that indicates the beginning of the content reproduced in mobile reception, and the head time code is set up by parameterizing the users' demands beforehand. As well, the head time code can be set up by adding the time code as an offset corresponding to various user reception modes to the time code up to the end of the CM preceding the desired content.

The mobile terminal 101 sends out (7) a display switchover demand to the content delivering apparatus 103 on the basis of the head time code. The mobile terminal also sends out to the content delivering apparatus 103 (8) an instruction to stop the delivery of content to the information receiving terminal apparatus 100 so that the reception of the content by the information receiving terminal apparatus 100 is stopped. The content delivering apparatus 103 now sends out (9) the content to the mobile terminal 101 that is the deliver destination. Thus, the switchover of the content to the mobile terminal 101 is finished.

On the contrary, the switchover of reception from the mobile terminal 101 to the information receiving terminal apparatus 100 is performed by causing the mobile terminal 101 to (10) specify the information receiving terminal apparatus 100. The information receiving terminal apparatus 100 is then (11) started. The mobile terminal 101 now sends out to the content delivering apparatus 103 (12) a demand for delivering contents to the information receiving terminal apparatus 100. Finally, the content delivering apparatus 103 (13) delivers contents to the information receiving terminal apparatus 100. The switchover of reception may be from the mobile terminal 101 to another mobile terminal 101. Moreover, switchover may take place by performing the process step indicated above at the process step number (5), in the information receiving terminal apparatus 100 that is the deliver destination, or another mobile terminal 101.

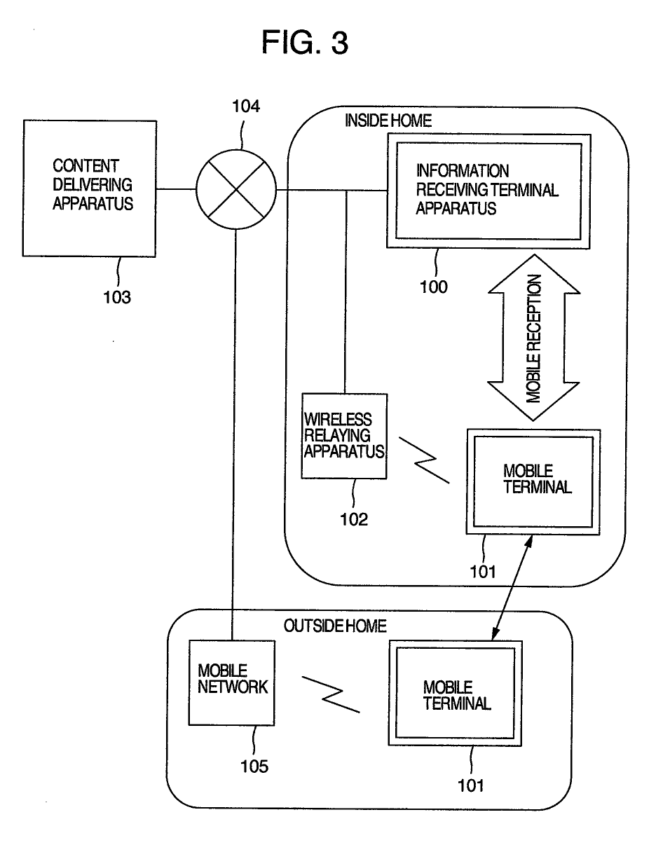

FIG. 3 shows a situation in which a family member has brought a mobile terminal 101 out of home. In this case, too, the uninterrupted reception of content can be done and several different services can also be enjoyed, irrespective of whether inside or outside home, through the use of a mobile network. Also, the mutual utilization of various services (e.g. browsing home pages throughout the Internet, transmission and reception of e-mails, on-line shopping, reception of TV programs, etc.) is possible. One example of the mutual utilization of various services is that if a cellular phone and a TV receiver are both connected with a network, TV programs can be viewed by the cellular phone and e-mails can be sent and received by the TV receiver, through the network. For example, the provision on the center side of a table listing the IDs proper to the apparatuses associated with the mobile network 105 and the IDs for the devices associated with a home LAN, enables such mutual utilization of services. Further, by storing the MAC address for a home LAN in the SIM card installed in the mobile terminal 101 overseas, the MAC address can be used when a mobile reception demand is sent out to the information receiving terminal apparatus 100 to effectuate the reception of contents. In addition, by inserting the SIM card into the mobile terminal 101 possessed by a friend or relative of the user, contents can be received by both the mobile terminal of the user himself and the mobile terminal of the friend or relative.

This card may be a memory card. The above described configuration can also judge whether there is a service agreement or not, thus being capable of coping with various services including a free reception without maturity of agreement.

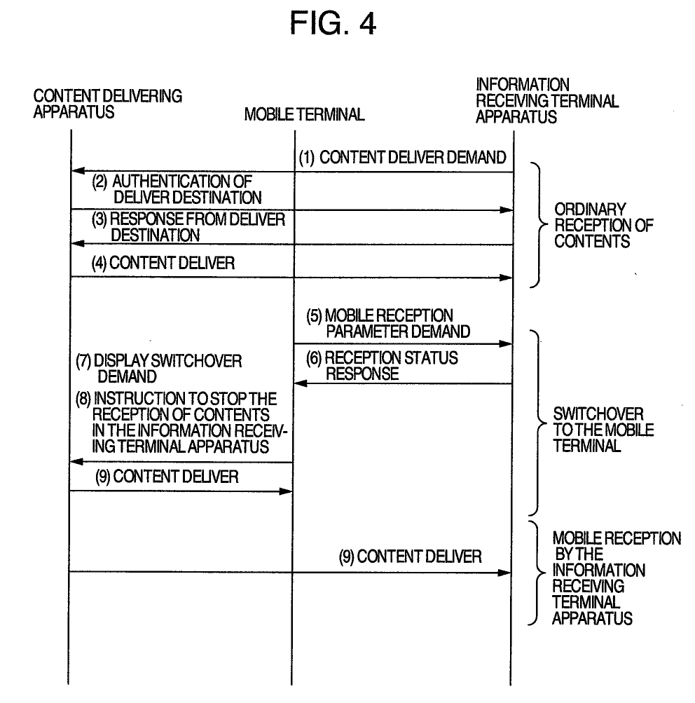

FIG. 4 illustrates an example of the sequence of protocol for mobile display switching wherein while a certain content is being received by the information receiving terminal apparatus 100 placed in, for example, the living room and enjoyed by all the family members, one of the members moves to the kitchen or washroom or outside the house and wants to receive the same content by his/her mobile terminal 101 there.

Following the same sequence as shown in FIG. 2, the process steps (1)˜(6) are performed, and the mobile terminal 101 sends out (7′) a mobile reception demand. This step (7′) is different from the step (7) in FIG. 2 in that even if one of the family members performs the mobile reception of a content by his/her own mobile terminal 101 while the other members are enjoying the same content on the information receiving terminal apparatus 100, the other members can continue to enjoy the ongoing content by the information receiving terminal apparatus 100.

In this protocol sequence, the mobile terminal 101 sends out to the content delivering apparatus 103 (8′) an instruction of whether or not it is necessary for the information receiving terminal apparatus 100 to continue the reception of contents. This step (8′) is different from the step (8) in FIG. 2 in that even if one of the family members performs the mobile reception of a content by his/her own mobile terminal 101 while the other members are enjoying the same content on the information receiving terminal apparatus 100, the information receiving terminal apparatus 100 is not turned off so that the ongoing content on the information receiving terminal apparatus 100 can be continuously enjoyed by the other members. Thus, the switchover of content reception can be done without disturbing the content reception on the information receiving terminal apparatus 100 by the other family members.

If the “necessary” step is executed in step (8′), the uninterrupted content reception can be performed by the mobile terminal 101 while the content reception by the information receiving terminal apparatus 100 is not influenced by the content reception by the mobile terminal 101 at all.

If the “not necessary” step is executed in step (8′), the information receiving terminal apparatus 100 can be turned off so that a bachelor (i.e. single person) can enjoy the mobile reception of contents without doing a series of troublesome manipulations when he enters the mode of mobile reception. He can also enjoy a prompt reception of contents by the information receiving terminal apparatus 100 as soon as he has returned home from an errand, by turning on the apparatus 100 with a mobile reception instruction sent to the apparatus 100 through the reverse application of the function described above.

In the protocol example shown in FIG. 4, the instruction of whether or not it is necessary for the information receiving terminal apparatus 100 to continue the reception of contents, is sent out to the content delivering apparatus 103. Alternatively, the instruction may be sent out to the information receiving terminal apparatus 100, and if the “not necessary” step is chosen, the reception or viewing of content by the apparatus 100 may be ceased, or the information receiving terminal apparatus 100 may cause the content delivering apparatus 103 to stop delivering contents. Such a case is effective especially when the information receiving terminal apparatus 100 is specified as the object of service. By storing the content reception history in the memory device installed in the information receiving terminal apparatus 100, an integrated management becomes possible. This makes it possible to get rid of illegal demands from vicious content service firms, to restrict an unlimited content reception by family members, and to prevent the reception of noxious contents. In this case, however, there is need for a storage area for storing the management information, and this may lead to the increase in system cost, the decrease in the capacities of storage areas for content record and download, and further to the complexity in management if the amount of information to be processed becomes considerable.

The content delivering apparatus 103 has the function of delivering plural content streams of each content in accordance with (8′) the information on whether or not it is necessary for the information receiving terminal apparatus 100 to continue the reception of contents, sent from the mobile terminal 101. It will be needless to say that more than one mobile terminal 101 may be used in this embodiment.

Further, if the mobile terminal 101 is provided with the function of calculating the time code for starting the mobile reception of contents, the mobile reception of contents can be realized without impairing the contents, by adding to the obtained value of the head time code for the mobile reception demand the value of the calculated time code particularly corresponding to the time point n second in advance depending on the system in consideration. Accordingly, when plural reception terminals (mobile terminal 101 and information receiving terminal apparatus 100) are involved in content reception, the time lag in content reception among the plural reception terminals can be coped with.

For example, let it be just assumed that a member of a family, while viewing a content on the information receiving terminal apparatus 100 with the other member of the family in the living room, temporarily leaves the living room for the washroom or his/her own bed room, still wants to enjoy the same content continuously on his/her mobile terminal 101 there, and wants to resume viewing the original content again on the information receiving terminal apparatus 100 when returning to the living room. In such a case, there is caused a time lag between the displays of the same content on the information receiving terminal apparatus 100 and the mobile terminal 101 since the mobile user needs some time for manipulating the mobile terminal 101 while moving to or being in, the washroom or the bedroom. As a result, when the mobile user returns to the living room and resumes viewing the original content, the display of content on the information receiving terminal apparatus 100 may advance in time the display of the same content on the mobile terminal 101 so that the mobile user may miss some part of the content.

If, for example, the mobile terminal 101 is provided with the function of monitoring the bit rate of the receiving content so as to synchronize the time codes for the contents received by the information receiving terminal apparatus 100 and the mobile terminal 101 to each other (exact synchronization will not be necessary, though), and if such control is enabled to reproduce only one frame of the content, to change the speed of reproduction or to skip CMs on the basis of the monitored bit rate, then the synchronization in content reception between the information receiving terminal apparatus 100 and the mobile terminal 101 can be effectuated. Either the mobile terminal 101 or the content delivering apparatus 103 may play a main part in such an operation.

Further, by monitoring the distance between the mobile terminal 101 and the information receiving terminal apparatus 100 by means of, for example, the GPS function installed in the mobile terminal 101, the synchronization of the content receptions may be controlled as the mobile terminal 101 approaches the information receiving terminal apparatus 100. By using this method, connection between a mobile terminal at a place outside home and the wireless LAN at home becomes possible via a mobile network.

According to this embodiment, at the time of switching the content display, the function to enhance the characteristic of content by overlapping the scene immediately before the switching on the scene immediately after the switching, may be realized.

The function for the uninterrupted reception of content while moving and the function for the content reception switchover from the information receiving apparatus 100 to the mobile terminal 101 or reversely, make it possible to enjoy the mobile uninterrupted reception of content inside home as well as outside home where the capability of the mobile terminal is specifically considerable. Thus, the uninterrupted switchover of content can be made between the mobile terminal 101 and the information receiving terminal apparatus 100 such as, for example, a TV receiver with a huge viewing screen.

Further, if the mobile terminal 101 is provided with the function of a camera, that is, the function of image capturing, the information captured away from home can be sent back via the center station to the information receiving apparatus 100 at home. Also by specifying the grandparents' home as the deliver destination, the images of their grandchildren can be delivered via a mobile network from a faraway mobile terminal to the information receiving terminal apparatus 100 at the grandparents' home.

Moreover, if plural information receiving terminal apparatuses 100 are connected with a network, it is possible to switch content reception from a user's mobile terminal 101 to any one of the plural information receiving terminal apparatuses 100 desired by the user.

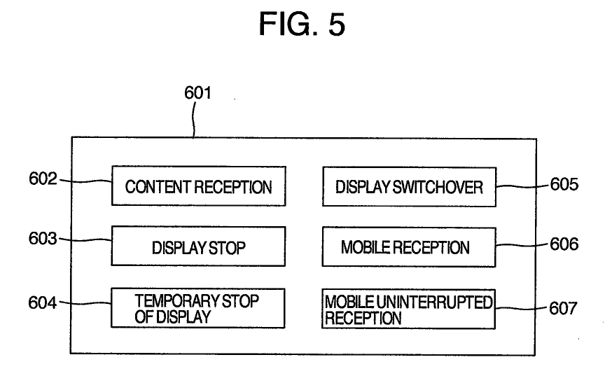

FIG. 5 shows an example of a menu 601 displayed on the manipulating screen of the mobile terminal 101. The menu includes “content reception” 602, “display stop” 603, and “temporary stop of display” 604 for remote control, and “display switchover” 605, “mobile reception” 606 and “mobile uninterrupted reception” 607 for switchover of content reception between two mobile terminals. This menu indicates that the system under consideration has a high manipulability. By selecting the respective items of the menu, the corresponding process steps in the sequence shown in FIG. 2 or 4 can be executed.

The menu screen can also be realized as a portal screen on the center side or an application on the terminal side.

### Embodiment 2

Furthermore, the contents stored in the storage media installed in the mobile terminal 101 or the contents delivered via the mobile network can be displayed on the display devices installed in the information receiving terminal apparatuses 100 and having different resolutions and screen sizes, whereas the contents being received by the information receiving terminal apparatuses 100 or the contents recorded or downloaded in the HDD devices can be displayed on the display devices installed in the mobile terminals 101. These situations will be described in detail below.

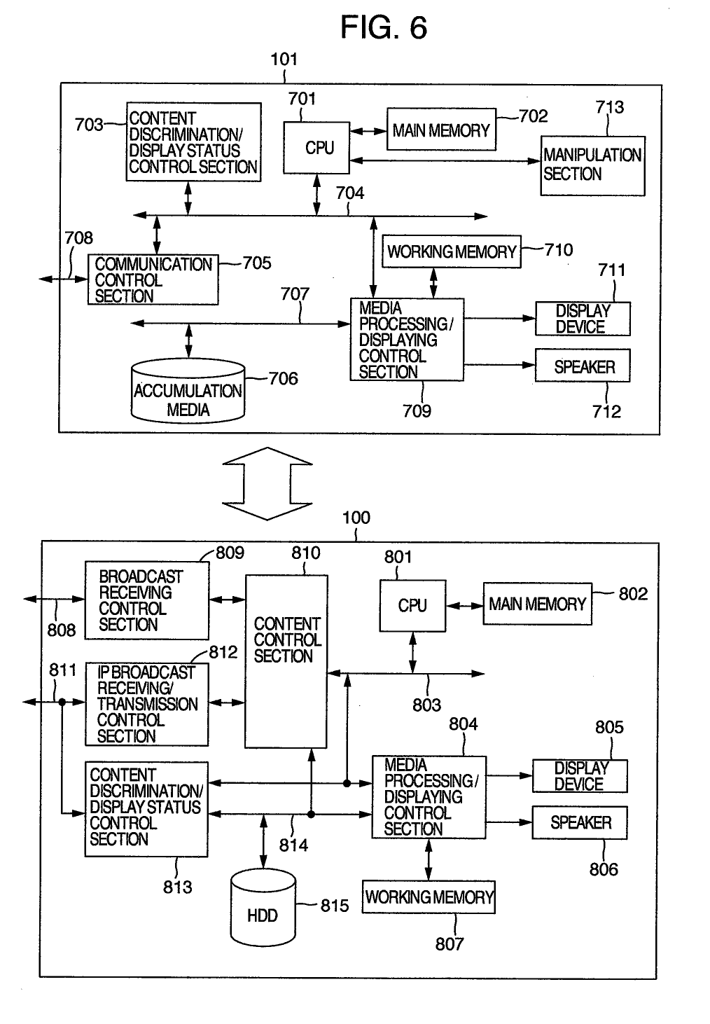

FIG. 6 shows in block diagram the circuit configurations of a mobile terminal 100 and an information receiving terminal apparatus 101.

The mobile terminal 101 incorporates therein a wireless interface section, which enables the bidirectional communication between the mobile terminal 101 and the information receiving terminal apparatus 100. In what follows, the mobile terminal 101 is described as a cellular phone, but any other portable device such as, for example, a game machine can be substituted for the cellular phone so far as it has a networking function and can communicate control and content information with the information receiving terminal apparatus 100. The control of the transmission and reception of data or information between the mobile terminal 101 and the information receiving terminal apparatus 100 will be described below.

A manipulation section 713 is provided with a key board including a cursor key, numeral keys, decision key, etc. A desired information receiving terminal apparatus 100 can be selected by manipulating these keys. To be concrete, the control of the display of contents can be performed by using the selection menu displayed on a display device 711 and the above mentioned key board. In addition to the ordinary operating mode, there is provided the display switching mode wherein the display of contents is switched over between the information receiving terminal apparatus 100 and the mobile terminal 101. In this display switching mode, it is also possible to provide a display of content having resolution and size suitable to the display device which is installed in the information receiving terminal apparatus 100 or the mobile terminal 101, by manipulating a single key or making a single touch onto the operating screen.

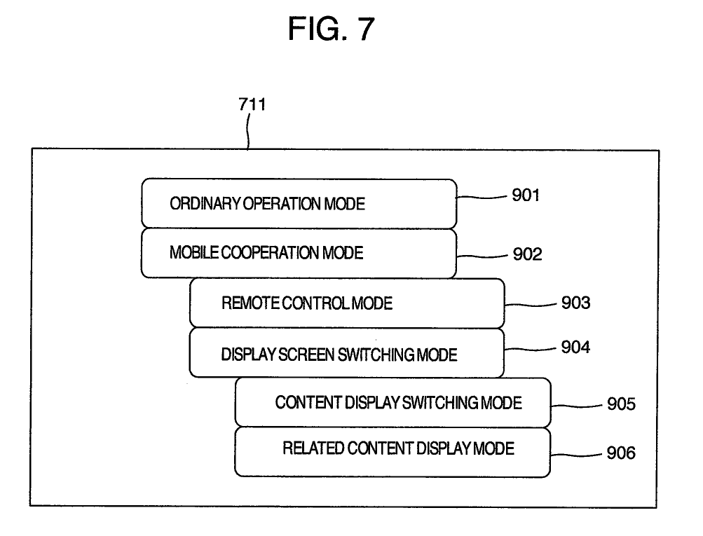

After operating the mobile terminal 101, a user views the selection menu screen, as shown in FIG. 7, displayed on the display device 711 of the mobile terminal 101 in accordance with the program stored in a main memory 702 connected with a CPU 701, to select the display content switching mode. This selection is made by moving the pointer onto a desired ion by using, for example, a cursor key of a key board (not shown) and pressing down a decision key (not shown). Alternatively, icon 905 may be selected by providing the screen of the display device 711 with a touch panel and making a direct touch onto the icon.

In the example shown in FIG. 7, the cursor is on the icon which indicates the content display switching mode 905, and as a result, the content display switching mode 905 is assumed to be selected. The selection menu is in the hierarchical structure and can be customized depending on the user's manipulation history so that item selection can be made through key manipulation. The menu screen shown in FIG. 7, for example, shows icons indicating the selective alternatives of display operations such as, for example, an ordinary operating mode 901 in which the mobile terminal 101 is selected, a mobile associated mode 902, a remote control mode 903, a display screen switching mode 904, a content display switching mode 905 and a related content display mode 906. In this example, six icons are displayed and they correspond respectively to the “ordinary operating mode”, the “mobile associated mode”, the “remote control mode”, the “display screen switching mode”, the “content display switching mode” and the “related content display mode”.

The “ordinary operating mode” is an ordinary operating mode in which no mobile associated function of the mobile terminal 101 is used. Namely, this mode is used when an ordinary phone call is made or a menu for the Internet access is displayed.

The “mobile associated mode” is a mode of operation associated with the information receiving terminal apparatus 100, including the step of storing in an accumulation media 706 of the information such as, the information on the processing capacity of a display 805 in the information receiving terminal apparatus 100 or a media processing/displaying control section 804 and the list of contents stored and downloaded in a HDD 815.

The “remote control mode” included in the “mobile associated mode” is the mode in which the mobile terminal 101 controls the operation of a remote controller (not shown) that remotely control the operation of the information receiving terminal apparatus 100. This remote control mode is similar to the remote control mode entered by the information receiving terminal apparatus 100, in which the content control section 810 is controlled, that is, the broadcast live contents received by a broadcast receiving control section 809, the contents to be recorded in the HDD 815, the streaming contents received from an IP broadcast receiving/transmission control section 812 or the contents to be downloaded into the HDD 815 are controlled.

The “display screen switching mode” included in the “mobile associated mode” is the mode in which content display is controlled with a single touch on the screen of the mobile terminal 100 through the function of a content discrimination/display status control sections 703, 813 installed in the information receiving terminal apparatus 100 and the mobile terminal 101.

The “content display switching mode” included in the “display screen switching mode” is the mode in which content display can be switched reciprocally between the display device 711 of the mobile terminal 101 and the display device 805 of the information receiving terminal apparatus 100.

The “related content display mode” included in the “display screen switching mode” is the mode in which when the content display is switched from the mobile terminal 101 to the information receiving terminal apparatus 100, the information associated with the content such as, for example, the web information related to the content from the Internet and the data such as superimposed titles are displayed on the display device 705 of the mobile terminal 101, and the sound information is outputted to the speaker 712. The above mentioned contents may includes not only video contents but also text data such as newspapers, JPEG date such as photographic pictures, music data and any other available digital contents. Namely, such contents include all the contents that the mobile terminal 101 and the information receiving terminal apparatus 100 can obtain from the Internet, the one or full segment broadcast, or the portable bridge media.

The main memory 702 that is the memory for executing the application program (e.g. program for controlling the switchover of the display screens) in the mobile terminal 101, retains the information that content display is to be switched from the mobile terminal 101 to the information receiving terminal apparatus 100, or from the information receiving terminal apparatus 100 to the mobile terminal 101. Depending on the information, discrimination is made between the content deliver destination and source in the display screen switching mode in accordance with the user's actions. The main memory 702 may be substituted in its function by, for example, the ROM storing therein the application program.

Also, the main memory 702 may retain the information for discriminating terminals which are the objects of display screen switchover (e.g. data such as MAC addresses proper to devices) and the information on the processing capacities of terminals (e.g. sizes of display devices, extensions for decodable video formats, and executable environments to be executed by a supporting player such as JPEG viewer, slide show, PDF viewer, etc.). The content discrimination/display status control section 703 interprets these pieces of information and the received data and operates to execute display screen switchover process.

The content discrimination/display status control section 703 in the mobile terminal 101 is controlled by the program executed on the CPU 701 in accordance with the mode selected on the display screen shown in FIG. 7. The output of the section 703 is delivered from the communication control section 705 of the mobile terminal 101 to the information receiving terminal apparatus 100. The IP broadcast receiving/transmission control section 812 of the information receiving terminal apparatus 100 communicates contents between the terminal 101 and the apparatus 100 via the network I/Fs 708, 811 and also obtains in the initial connection sequence a list containing the display resolutions and screen sizes of and the sorts and titles of contents retained in, the mobile terminal 101 and the information receiving terminal apparatus 100.

The list of contents may utilize the format whose standard is defined by DLNA. Thus, the content discrimination/display status control section 703 makes decision on whether the information obtained from the terminal is of MPEG-2 format, MPEG-4/AVC video format, standard resolution, high resolution, AAC audio format or MP3 audio format; automatically starts up the media processing/display control section 709; and operates to process contents and to produce display data best suitable to the display 711. By providing such a function for both the mobile terminal 101 and the information receiving terminal apparatus 100, content reception can be switched over from the mobile terminal 101 to the information receiving terminal apparatus 100, or vice versa; music content can be reproduced by the speakers of the information receiving terminal apparatus 100 capable of reproducing sounds with high quality; or the reception of stationary images such as photographic pictures having high resolutions can be switched over.

Further, the content discrimination/display status control section 703 not only discriminates the sorts of contents to be reproduced but also analyzes the information associated with multiplexed contents. For example, it delivers the information on URLs in the Web sites to the CPU 701 in the format suitable for processing by the CPU 701, and displays only the Web information obtained by the CPU 701 on the display screen of the mobile terminal 101. Namely, the content discrimination/display status control section 703 has the function of performing the display of contents that are the object of processing in the mobile terminal 101 at hand in parallel with display screen switching.

Accordingly, each of the main and ordinate contents being received by the mobile terminal 101 can be switched over to the information receiving terminal apparatus 100, or each of the main and ordinate contents being received by the information receiving terminal apparatus 100 can be switched over to the mobile terminal 101. In this embodiment, the object of switching is content display, but audio data and/or image data can also be subjected to such switchover.

The information receiving terminal apparatus 100 obtains such information as formats on the basis of the information delivered from the media processing/displaying control section 804, executes data processing suitable for the specifications of the display device 711 of the mobile terminal 101 and the display device 805 of the information receiving terminal apparatus 100, and, as a result, can perform content display suitable to the respective apparatuses.

The content discrimination/display status control sections 703 and 813 manage, through the operation of the mobile terminal 101, which of the apparatuses is displaying a content, and whether the displayed content is delivered from the mobile terminal 101 or the information receiving terminal apparatus 100, so that they make decision on whether, in the next operation of the mobile terminal 101, the content display is switched over from the mobile terminal 101 to the information receiving terminal apparatus 100, or vice versa, executing the content display switchover.

Accordingly, irrespective of whether the content in consideration is delivered from the mobile terminal 101 or the information receiving terminal apparatus 100, the operation of the mobile terminal 101 enables the content display switchover between the apparatuses having different display sizes and/or different image resolutions. In addition, the mobile terminal 101 at hand can allow various operations linked with the information receiving terminal apparatus 100.

### Embodiment 3

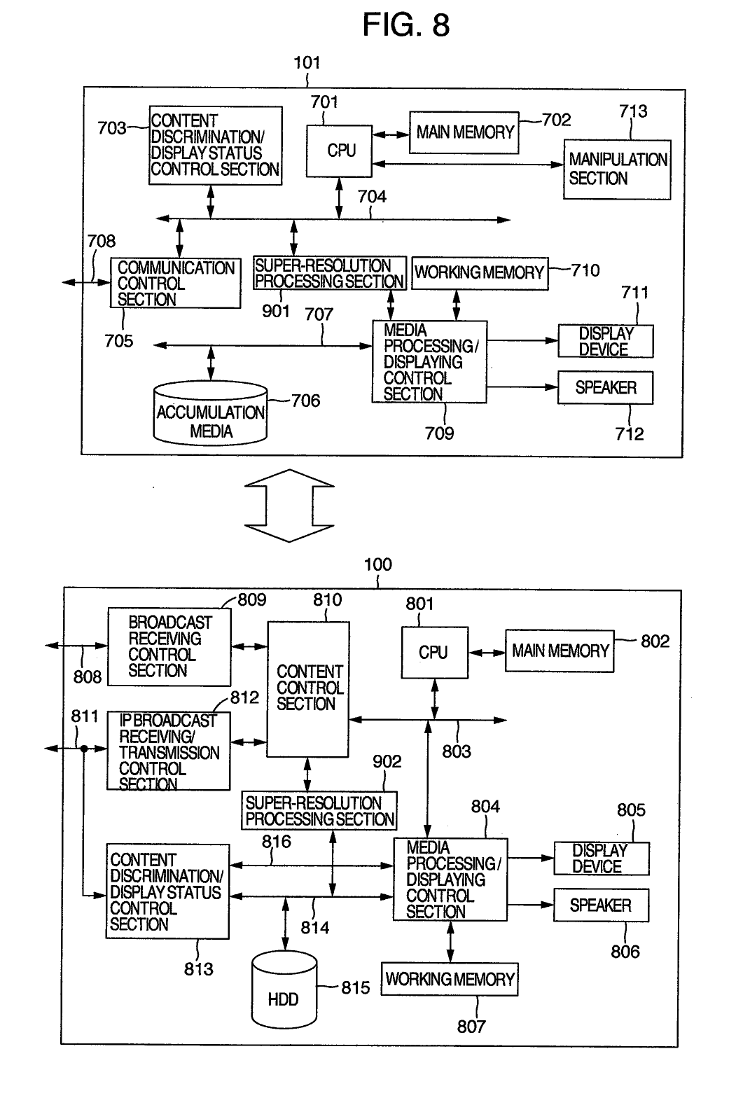

FIG. 8 shows in block diagram the circuit configurations of the mobile terminal 101 and the information receiving terminal apparatus 100, both using super-resolution techniques. The provision of super-resolution processing sections 901, 902 allows super-resolution processing to be performed on the basis of the information regarding the sorts of contents, obtained from the content discrimination/display status control sections 703 and 813. Thus, the display of high-quality contents becomes possible irrespective of the available resolutions of the source contents.

It should be further understood by those skilled in the art that although the foregoing description has been made on embodiments of the invention, the invention is not limited thereto and various changes and modifications may be made without departing from the spirit of the invention and the scope of the appended claims.

1. A terminal-cooperated system for the uninterrupted reception of contents comprising:
a content delivering apparatus for delivering video contents;
a first terminal for outputting the video contents received from the content delivering apparatus; and
a second terminal for obtaining the information on the video contents outputted from the first terminal and transmitting the information on the demand for reception of the video contents and the information on whether or not the uninterrupted switching of video content to the first terminal is necessary.

2. The terminal-cooperated system for the uninterrupted reception of contents, as claimed in claim 1, wherein when the second terminal transmits the demand that the video contents are to be viewed by the first terminal, the reception of video content by the second terminal is so controlled that the time code of the video content being received by the first terminal may be adjusted to that of the video content to be received by the second terminal.

3. The terminal-cooperated system for the uninterrupted reception of contents, as claimed in claim 1, wherein the content delivering apparatus switches the picture qualities or the data compression schemes of the video contents depending on the sorts of the first and the second terminals.

4. A content reception terminal comprising:
an information obtaining section for obtaining the information on the video content which is being received by another content reception terminal by a user; and
an information transmitting section for transmitting the information on the demand for the reception of the video content to a content delivering apparatus that is delivering the video content and also transmitting the information on whether or not the uninterrupted switching of content to another content reception terminal is necessary.

5. A content delivering apparatus comprising:
a transmitting section for transmitting contents;
a receiving section for receiving the demand for delivering contents from a first terminal and also receiving the information on whether or not the uninterrupted switching of content to a second terminal is necessary; and
a control section which, when the receiving section receives the information that the uninterrupted switching of content to the second terminal is not necessary, causes the transmitting section to stop the transmission of content to the second terminal and instead to transmit the content to the first terminal.

6. A terminal-cooperated method for the uninterrupted reception of contents, comprising:
a first step of causing a first terminal to receive a content; and
a second step of receiving a demand for a second terminal to receive the content uninterruptedly, and
a third step of controlling the reception by the second terminal of content in such a manner that the time information on the content being received by the second terminal and the time information on the content being received by the first terminal can be adjusted to each other.

7. A terminal-cooperated system for the reception of contents, comprising:
a unit for holding the information on screen display switching; and
a unit for switching the output of display contents from a mobile terminal to an information receiving terminal apparatus and from the information receiving terminal apparatus to the mobile terminal, by operating the mobile terminal on the basis of the information on screen display switching.

8. The terminal-cooperated system for the reception of contents as claimed in claim 7, further comprising:
a unit for discriminating the sorts of contents;
a unit for transmitting and receiving the information on the display resolution and the screen size of the information receiving terminal apparatus or the mobile terminal apparatus which is the object of content reception switching; and
a unit for changing the display resolution and the screen size on the information.

9. The terminal-cooperated system for the reception of contents, as claimed in claim 8, wherein the resolution is changed through the use of super-resolution technique.

10. The terminal-cooperated system for the reception of contents, as claimed in claim 7, wherein when the display contents output is switched from the mobile terminal to the information receiving terminal apparatus, the menu screen such as, for example, the information on contents is displayed on the mobile terminal.

11. The terminal-cooperated system for the reception of contents as claimed in claim 10, wherein the menu screen includes the information obtained from the Internet.
